(19) United States
(12) Patent Application Publication
(10) Pub. No.: US 2024/0354791 A1
(43) Pub. Date: Oct. 24, 2024

(54) FEATURE-VALUE PERTURBATION FOR ANALYSIS OF DIFFERENTIATED SUBGROUPS

(71) Applicant: International Business Machines Corporation, Armonk, NY (US)

(72) Inventors: Isaiah Mulang' Onando, Nairobi (KE); William Ogallo, Nairobi (KE); Girmaw Abebe Tadesse, Nairobi (KE); Aisha Walcott, Nairobi (KE)

(21) Appl. No.: 18/137,424

(22) Filed: Apr. 20, 2023

(51) Int. Cl. G06Q 30/0204; G06F 17/18

(52) U.S. Cl. CPC G06Q 30/0204; G06F 17/18

(57) ABSTRACT

A plurality of key features that contribute to a level of anomalousness of an anomalous subgroup are identified. One or more minimal perturbations to a set of features of the anomalous subgroup that result in a reduction of the level of anomalousness are identified. The application of one or more minimal perturbations to members of the anomalous subgroup is facilitated.

### BACKGROUND

The present invention relates generally to the electrical, electronic and computer arts and, more particularly, to computer-implemented artificial intelligence (AI), machine learning (ML) and the like.

Analyzing the behavior of populations in response to interventions is quite pertinent, in order to unearth differentiated patterns, understand sub-populations that require specialized attention, and design future interventions. In particular, the detection of anomalous samples that exhibit deviating behavior from the expected (such as variability in healthcare responses) is visibly attracting research interest with the aim to discover subgroups in given data that deviate from some concept of normality. These discovery methods can be applied in several domains, such as healthcare, cyber-security, insurance and finance sectors, industrial monitoring, and the like. Despite this growing research interest and breadth of applicability, discovery method approaches are still limited to describing the detected anomalous subgroups; hence, conventional techniques barely offer valuable insights, limiting interpretability of these data-driven techniques in, for example, clinical practices.

Existing solutions primarily encompass areas such as anomaly detection, counterfactual analysis, and techniques for perturbations. In the present context, anomaly detection relates to discovery methods that identify anomalous subgroups and are special forms of anomaly detection methods. However, the discovery of differentiated subgroups involves automatically analyzing a population to separate the set of individuals that exhibit behavior that differs from the average population, but fails to perform post discovery analysis of the anomalous subgroups. Post discovery analysis of anomalous subgroups are special forms of counterfactual analysis, that entails a “what if” analysis on the features and feature values in a model. Current discovery methods, akin to anomaly detection, do not perform further analysis and characterization of the anomalous subgroups; on the other hand, counterfactual analysis methods have been applied to supervised machine learning. Counterfactual analysis methods try to optimize a cost function that will identify an example close enough to a single data point in the training data. Even though post discovery analysis of anomalous subgroups seeks to analyze the feature values in the data, post-discovery is a special form of counterfactual in this domain that does not map directly to traditional counterfactuals.

In general, subgroup analysis, a form of anomaly detection, relates to the discovery of a differentiated subgroup and identifies subgroups with special characteristics of interest. Current discovery methods do not provide characterization of the discovered subgroups to enhance explainability, and do not provide for practical remedial implementations. The post discovery question is a search task over the combinatorial feature space of the anomalous subgroup and the complement group.

### BRIEF SUMMARY

Principles of the invention provide techniques for feature value perturbation for analysis of differentiated subgroups. In one aspect, an exemplary method includes the operations of identifying a plurality of key features that contribute to a level of anomalousness of an anomalous subgroup; identifying one or more minimal perturbations to a set of features of the anomalous subgroup that result in a reduction of the level of anomalousness; and facilitating applying the one or more minimal perturbations to members of the anomalous subgroup.

In one aspect, a non-transitory computer readable medium comprises computer executable instructions which when executed by a computer cause the computer to perform the method of identifying a plurality of key features that contribute to a level of anomalousness of an anomalous subgroup; identifying one or more minimal perturbations to a set of features of the anomalous subgroup that result in a reduction of the level of anomalousness; and facilitating applying the one or more minimal perturbations to members of the anomalous subgroup.

In one aspect, an apparatus comprises a memory and at least one processor, coupled to the memory, and operative to perform operations comprising identifying a plurality of key features that contribute to a level of anomalousness of an anomalous subgroup; identifying one or more minimal perturbations to a set of features of the anomalous subgroup that result in a reduction of the level of anomalousness; and facilitating applying the one or more minimal perturbations to members of the anomalous subgroup.

As used herein, “facilitating” an action includes performing the action, making the action easier, helping to carry the action out, or causing the action to be performed. Thus, by way of example and not limitation, instructions executing on a processor might facilitate an action carried out by instructions executing on a remote processor, by sending appropriate data or commands to cause or aid the action to be performed. Where an actor facilitates an action by other than performing the action, the action is nevertheless performed by some entity or combination of entities.

Techniques as disclosed herein can provide substantial beneficial technical effects. Some embodiments may not have these potential advantages and these potential advantages are not necessarily required of all embodiments. By way of example only and without limitation, one or more embodiments may provide one or more of:
intervention planning: understanding which covariates in a feature space can be perturbed to avoid a given condition, or accelerate the effect of an intervention to enhance planning for future interventions;
intervention planning in healthcare: insightful analysis of anomalous subsets and subgroups can help future intervention planning (as used herein, a subset is a set of features and corresponding feature values and a subgroup is a portion of a population characterized by a given set of feature values);
feature perturbations for post discovery analysis.
determining the influence of feature values on a loss of anomalousness;
scalable cross-substitution of features values;
post-discovery analysis of anomalous subsets and subgroups, including identifying the key contributors to anomalousness and identifying the minimal perturbations that result in a reduction of anomalousness;
improvements to efficiency and interpretability of the detected subgroup description;
extra insights regarding the identified subgroups and which features and feature values have the greatest contribution to the abnormality;
improves the technological process of computerized AI/ML by providing a reduced search space for identifying the least changes necessary to significantly decrease the anomalousness, thereby reducing memory and/or central processing unit (CPU) requirements as compared to prior art techniques;
identification of the set of feature value substitutions necessary to alter an anomalous subset to obtain a normal set;
modifying, generating, and administering a set of prescribed therapies based on feature perturbations implemented for post discovery analysis; and
enables future interventions/remedial actions which can be better targeted as a result of the discovered substitution set.

These and other features and advantages will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1A illustrates a first example of subgroup discovery and analysis, in accordance with an example embodiment;

FIG. 1B illustrates the distribution of responses for the non-anomalous population vs. the portion of the population in the anomalous subgroup after changing the feature set of the anomalous subgroup, in accordance with an example embodiment;

FIG. 2 illustrates a dataflow of an example method for using feature-value perturbations, in accordance with an example embodiment;

FIG. 3 represents a model for exploring the feature space to identify the minimal perturbations to a set of features of an anomalous subgroup that result in a reduction of the level of anomalousness, in accordance with an example embodiment;

FIG. 4 illustrates the range of a distribution corresponding to an overall population and five subgroups, in accordance with an example embodiment;

FIG. 5 is an algorithm for performing cross-substitution, in accordance with an example embodiment;

FIG. 6 are tables describing an anomalous subset (Table 2) and its complement subset (Table 3), in in accordance with an example embodiment;

FIG. 7 is an example list of possible substitutions, in accordance with an example embodiment;

FIG. 8 is a table that illustrates the relevance of feature values based on the standard deviations from the global average, in accordance with an example embodiment;

FIG. 9 is a table that illustrates the post-discovery scores for single substitutions of the two most significant anomalous feature values, in accordance with an example embodiment;

FIG. 10 illustrates the cross-substitution of single feature values in the anomalous subset against the two measures of effect: p-value and odds ratio, in accordance with an example embodiment;

FIG. 11 illustrates multiple [m:1] cross-substitutions of feature values in the anomalous subset against the two measures of effect: p-value and odds ratio, in accordance with an example embodiment;

FIG. 12 illustrates an example tree for identifying the minimal perturbations to a set of features of an anomalous subgroup that result in a reduction of the level of anomalousness, in accordance with an example embodiment;

FIG. 13 is an example backtracking algorithm for identifying the minimal perturbations to a set of features of an anomalous subgroup that result in a reduction of the level of anomalousness, in accordance with an example embodiment;

FIG. 14 is a flowchart for determining feature-value perturbations that change an anomalous subgroup to non-anomalous for an example clinical practice system, in accordance with an example embodiment; and

FIG. 15 depicts a computing environment according to an embodiment of the present invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of inventions described herein will be in the context of illustrative embodiments. Moreover, it will become apparent to those skilled in the art given the teachings herein that numerous modifications can be made to the embodiments shown that are within the scope of the claims. That is, no limitations with respect to the embodiments shown and described herein are intended or should be inferred.

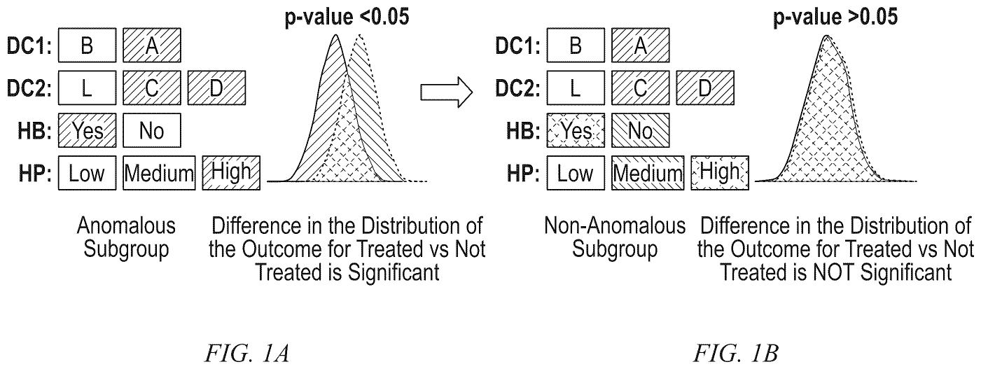

FIG. 1A illustrates a first example of subgroup discovery and analysis, in accordance with an example embodiment. The discovery identifies differentiated subgroups with special characteristics of interest. For example, in evaluating medical treatments, it is often desirable to identify subgroups of a population that respond extremely well or extremely poorly to a prescribed treatment. Similarly, it may be desirable to detect contagious outbreaks and the like. Conventional discovery methods, however, do not provide characterization of the discovered subsets to enhance explainability, and for practical remedial implementations.

### Discovery Methods

Methods that discover differentiated subgroups can be categorized according to the task they perform (as follows):

Examining treatment effects: given multiple treatments, identify combinations of treatment and a sub-population(s) associated with anomalous outcomes;

Disease surveillance: observe data streams for early detection of emerging outbreaks; and

Systematic bias in classifiers: detecting if a classifier has statistically significant bias.

### Limitations of the Discovery Methods

Discovery methods primarily concentrate on the identification of anomalous subsets and subgroups; hence, the output is merely descriptions of the identified subset (e.g., a list of features and feature values that contribute to the anomalousness of the identified subset). Conventional discovery methods do not reveal the underlying insights on the weighted contribution of features and feature values to the anomalousness of the identified subgroups.

Descriptions of the identified subgroups output from the discovery methods do not extend sufficient insights to enable future planning. A special form of counterfactual analysis can reveal alterations to feature values that will provide explainability and insights to assist future interventions.

In one example embodiment, the analysis of the output from discovery methods is extended, and assists in understanding the output of subgroup analysis methods like the Autostrat method as mentioned in Oshingbesan A, Omondi WG, Tadesse GA, Cintas C, Speakman S. Beyond Protected Attributes: Disciplined Detection of Systematic Deviations in Data. In Workshop on Trustworthy and Socially Responsible Machine Learning, NeurIPS 2022. The post-discovery analysis seeks to unearth insights presented in the otherwise descriptive discovery methods outputs, by performing sufficient perturbations to the feature values.

Post-discovery analysis of anomalous subsets includes:
identifying the key feature contributors to anomalousness.
identifying minimal perturbations that result in a reduction of anomalousness; and
improvements to efficiency and interpretability of the detected subgroup description.

Given a dataset of multiple features, and the output of a discovery method (such as subset scanning method), can a minimalistic set of changes on the identified subgroups be derived, necessary to make a significant drop in the degree of anomalousness of the subgroup (i.e., identifying the least changes in feature values necessary to make a member of the divergent group resume normality)? The post discovery question is a search task over the combinatorial feature space of the anomalous subgroup and the complement group. This is accomplished in two steps: i) first, identifying features with the most weight on the anomalous score, and then ii) by perturbation, identifying the least number of changes that significantly reduce anomalousness.

Thus, one question is: what is the least change(s) needed in the features of the anomalous subset to lose anomalousness; that is, to create a new subgroup that is non-anomalous?

### Explainability & Post Discovery Analysis of Anomalous Subpopulations

As noted above, one challenge of post discovery analysis is to identify the smallest change to the features set of an anomalous subgroup that would make it not anomalous; that is, what change to the definition of the subgroup would create a new subgroup that exhibits a typical characteristic, such as a typical response to a medical treatment, rather than an extremely poor or extremely good response to the medical treatment. The post discovery question is a search task over the combinatorial feature space of the anomalous subgroup and the complement group (the subgroup that includes all the samples that are not in the anomalous subgroup).

### Solution: Post-Discover Analysis Via Feature-Value Perturbations

What is the least change needed to the features of an anomalous subset to remove the anomalousness? FIG. 1A illustrates the distribution of responses for the non-anomalous population (left graph) vs. the portion of the population in the anomalous subgroup (right graph), in accordance with an example embodiment. In the example of FIG. 1A, the non-anomalous population is a population that did not receive medical treatment and the anomalous subgroup is the population that received treatment and that responded well to the treatment. In the example of FIG. 1A, the anomalous subgroup is characterized by demographic characteristic 1 (DC1) having a value of A (possible values are A and B), demographic characteristic 2 (DC2) having a value of C or D (possible values are L, C, and D), a health-related behavior (HB) having a value of YES (possible values are YES and NO), and a health-related physical (HP) characteristic having a value of high (possible values are low, medium, and high), and exhibits a substantially different distribution (response) when subjected to the medical treatment (in comparison to the untreated population).

FIG. 1B illustrates the distribution of responses for the non-anomalous population vs. the portion of the population in the anomalous subgroup after changing the feature set of the anomalous subgroup, in accordance with an example embodiment. As illustrated in FIG. 1B, changing the health-related physical characteristic of the feature set of the anomalous subgroup from having a value of high to having a value of medium and changing the health-related behavior of the feature set of the anomalous subgroup from having a value of YES to NO changes the distribution of the subgroup to the normal distribution. Thus, the health-related physical characteristic and the health-related behavior are considered as being the most relevant factors in the anomalous distribution (and therefore in the anomalous medical response).

In one example embodiment, a method for post-discovery analysis of differentiated output (beyond discovery) is disclosed. The method extends the characterization of anomalous subgroups to enable better understanding and future targeting of interventions. Feature value perturbations are applied to identify which feature value substitutions are sufficient to cause a significant drop in anomalousness. The disclosed techniques combine the three different niches discussed above. In one example embodiment, a technique for determining the feature perturbation that has the least number of changes to generate the cited effect is disclosed.

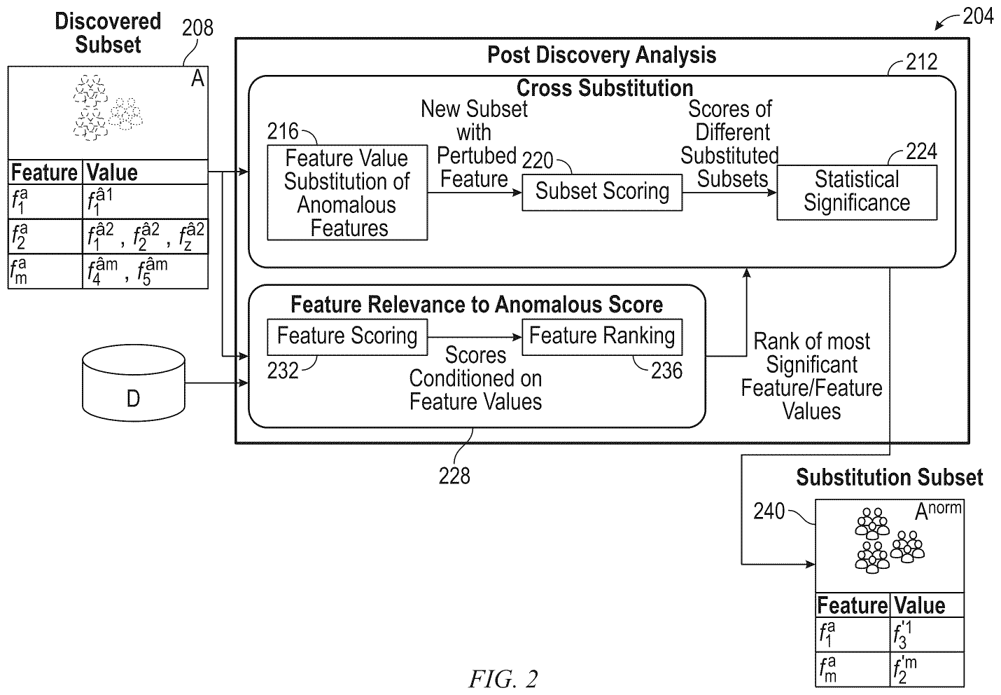

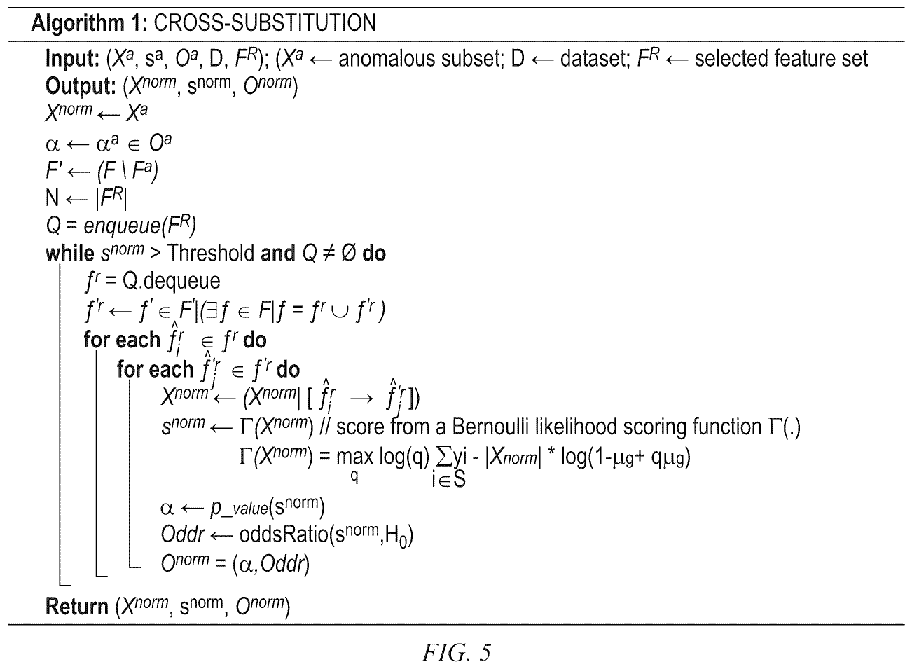

FIG. 2 illustrates a dataflow of an example method 204 for using feature-value perturbations, in accordance with an example embodiment. The approach takes in an anomalous subset together with the original dataset as input and aims to identify feature substitutions that result in loss of anomalousness. It includes two major subtasks, namely: i) feature relevance ranking that takes an anomalous subset and identifies the most significant features and feature values contributing to anomalousness; and ii) cross-substitution that identifies the possible permutations of feature values within the anomalous subset by scoring minimally altered subsets obtained through replacing features values drawn from the anomalous subset with features values drawn from the complement set. Note with regard to the block diagram of FIG. 2 that the Algorithm 1 of FIG. 5 represents an exemplary implementation of cross-substitution block 212. Feature scoring and ranking techniques will be apparent to the skilled artisan from the teachings elsewhere herein.

In one example embodiment, the features and features values that characterize the anomalous group 208 are input to the system 204. A feature relevance unit 228 ranks the features based on their significance in triggering the anomalous distribution. Initially, features are considered one-by-one (individually) and their contribution to the anomalous distribution is scored (operation 232). The features are then ranked based on the determined features scores (operation 236).

In one example embodiment, perturbations of the features values are tested during the cross-substitution phase 212. Initially, a feature value from the complement set is substituted into the anomalous set, starting with the highest ranked feature(s), to create a new subset of features (and corresponding subgroup) (operation 216). The new subset is then scored based on its distribution, the change in the distribution of the anomalous subgroup in comparison to the distribution of the complement subgroup, and the like (operation 220). Scores of the different subsets (corresponding to different perturbations) are statistically evaluated to identify the perturbations of the feature values 240 (resultant feature value set after substitutions) that bring the anomalous distribution to a normal distribution (operation 224).

### Determining Feature Relevance to an Anomalous Score

The deviating subset of features (for the anomalous subgroup) produced by the discovery method (such as subset scanning approaches) are characterized by features and feature values that contribute to the deviation (anomalousness) subgroup. The intuition behind feature relevance is that not all feature values contribute equally to the anomalousness of a subgroup, as measured by the anomalous score. The feature relevance score, therefore, strives to identify the set of features (and feature values) in the anomalous subset that induce the greatest impact on the anomalous score. Such features are prime candidates for analysis as a change in their values have a higher likelihood of resulting in a significant drop in the anomalous score.

In one example embodiment, feature relevance scoring takes the output tuple A=(X^{a}, s^{a}, O^{a})) from a discovery method, and the dataset D, where X^{a} is the identified differentiated (anomalous) subset, s^{a} is the anomalous score, and O^{a} is a tuple of the measures of effect (namely: p-value, and odds-ratio).

The scoring of records with each feature value, where a feature selection routine β(·) proceeds by first obtaining the scores of each record containing a specific feature value of interest (a record is only considered if it has the feature value of interest). The idea is to obtain the deviation of this feature value from the overall dataset, thereby determining the possible effect on the deviating/anomalous subset. Two possible deviation scores are attainable, namely: i) the standard deviation of records conditioned on a specific feature value from the expected value of the dataset (global average); and ii) the deviation of the marginal expected value of the feature value (the average of the scores of all records containing the feature value of interest) from the global average.

In one example embodiment, the standard deviation of a given feature value is computed where the global mean (μ_{g}), the overall mean of outputs in the original dataset, is defined as:

$${μ}_{g} = \frac{{\sum }_{i} ( {y}_{i} )}{\vert D \vert}$$

In one example embodiment, the subset mean (μₛₛ), the mean of all outputs of records containing feature values from the deviating subset is then computed. Note, however, that this is but one approach to obtaining a weighted score for the ranking of feature values. For this specific approach, both the global mean and the subset mean are used; however, an implementation could choose to include another score or drop one for the other. In the below, N is the number of features.
For each feature value (fv) in the deviating (anomalous) subgroup:
   records-fv←each record in D if the record has fv;
      For every i^{th} record in records-fv:
         obtain the marginal output for the feature value for the i^{th} record: αᵢ=y value of the i^{th} record in the set of records with the feature value;
   obtain a score (the weight) of each feature|value pair in the anomalous subset by computing the standard deviation from the mean:

$${σ}_{g} = \sqrt{\frac{\sum {( {α}_{i} - {μ}_{g} )}^{2}}{N}}$$

Deviation of the Feature Value Average from the Global Average

In one example embodiment, the deviation of the feature value average from the global average is computed:
For each feature value (fv) in the deviating (anomalous) subgroup:

$${e}_{j} = 𝔼 ( {f}_{j}^{a} ) = \frac{{\sum }_{i} ( {y}_{i} \vert {f}_{j}^{i} = {f}_{j}^{a i} )}{\vert ( {x}_{i} \vert {f}_{j}^{i} = {f}_{j}^{a i} ) \vert} ;$$

calculate the deviations of eⱼ from the mean expected value of the dataset μ_{g}, as: δⱼ=eⱼ−μ_{g}; and
rank the feature values based on their calculated deviations:

$$rank ( {f}_{j}^{a} ) < rank ( {f}_{k}^{a} ) if {δ}_{j} > {δ}_{k}$$

### Cross-Substitution

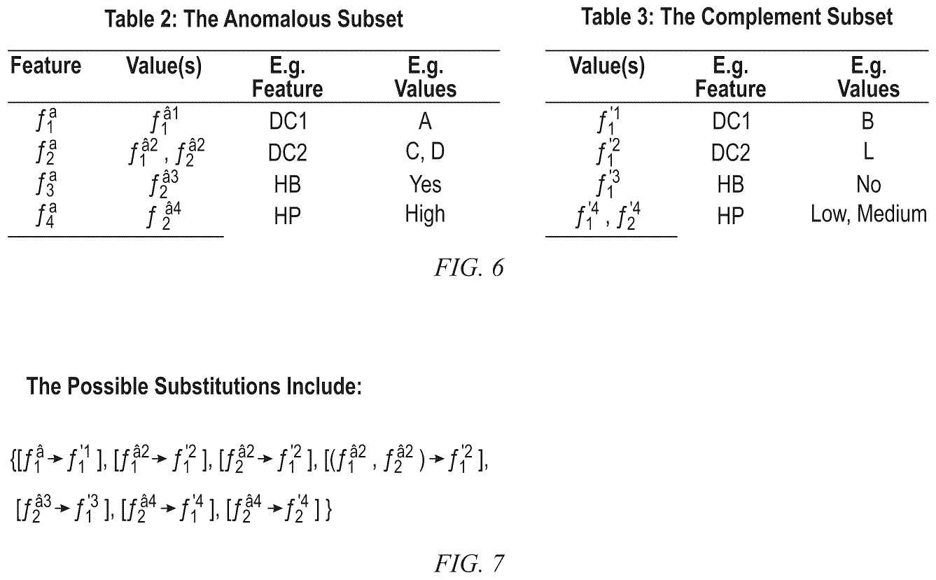

After identifying the features and feature values that are most relevant to the anomalousness of a subgroup, a cross-substitution process is performed. The aim is to find the minimal changes in the anomalous subset of feature values that results in a significant drop in the anomalous score. This is achieved by drawing feature values from the compliment set to substitute as feature values in the anomalous subset. Assume, for example, an anomalous subset described in Table 2, and its complement described in Table 3, of FIG. 6. (FIG. 7 is an example list of possible substitutions, in accordance with an example embodiment.)

A single substitution produces a new subset of feature values that is different from the discovered (anomalous) subset of feature values. These perturbations are repeatedly carried out until the space of possible substitutions is exhausted. If this space is large and complex, the results of the feature selection phase become invariably important. The cross-substitution therefore begins alteration of the feature values in the order of the feature ranking obtained from the feature relevance scoring. Each of the generated subsets are then scored with the same scoring function used by the discovery method Γ(·) (such as the Bernoulli likelihood ratio scoring statistic). This scoring aims to generate new measures of effect O. A statistical significance test is used to determine whether the new subgroup loses the anomalousness (typically a p-value statistic or odds-ratio is used, obtained in a similar procedure as described under the scoring section below). The stopping criterion is attained when the statistical significance of a subset surpasses a given threshold. Algorithm 1 of FIG. 5 elaborates the cross-substitution analysis steps.

Scoring the Resultant Subgroups from Perturbation

The cross-substitution aims to identify the set of substitutions (features from the deviant subgroup paired with feature values from the complement subgroup) which, when carried out, defines a resulting subset that is no longer divergent (non-anomalous). To verify whether the created subgroup from the cross-substitutions is no longer anomalous, the subset is scored with the same score of the discovery method (an expectation maximization scoring statistic). Further, measures of effect are introduced to identify the significance of the levels of drop from the substitutions.

### Cross Substitution Set

The cross-substitution set is the minimal set of “anomalous-complement” feature values found to be collectively necessary to reduce the score of divergence to match or nearly match the score of the average population. Anomalous features are extracted that describe the subset of the samples above as a logical (AND & OR) combination of features and their values. Characterization metrics are computed as scores to describe the level of divergence (anomalousness), odds ratios between the identified divergent subgroup and the whole population, 95% confidence interval and empirical p-value of the odds ratios:

$$Γ ( {X}^{norm} ) = {max}_{q} log ( q ) {\sum }_{i ∈ S} {y}_{i} - \vert {X}^{norm} \vert * log ( 1 - {μ}_{g} + q {μ}_{g} )$$

measures of effect: the measures of effect are statistical scores that determine the significance of the drop in divergence caused by the perturbations as follows:
significance testing is done to validate the significance of the identified subgroup with randomization testing; and
an odds ratio computation is performed that evaluates the likelihood of experiencing the outcome of the interest in each subset resulting from the substitutions compared to the overall populations. The result of the odd-ratio calculation is a vector of length equal to the number of unique values per feature.

$${o}_{m}^{u} = \frac{{μ}_{m}^{u} / 1 - {μ}_{m}^{u}}{{μ}_{g} / 1 - {μ}_{g}}$$

where oₘ^{u} is the odds ratio of the μ^{th} value of the m^{th} feature, μₘ^{u} is the mean score of all records with the μ^{th} value of the m^{th} feature, and μ_{g} is the global mean (of all records).

FIG. 5 is an algorithm for performing cross-substitution, in accordance with an example embodiment. In one example embodiment, an anomalous subset X^{a}, a score s^{a} (the highest score for any subset encountered for the anomalous subset), a tuple [symbol] ^{a} (odds ratio and a measure of effect (statistical significance)), the dataset [symbol] , and the selected feature set [symbol] are obtained. The output includes the normal subset X^{norm}, the normal score s^{norm}, and the normal tuple [symbol] ^{norm} The desired set of features X^{norm} is set to the anomalous set of features X^{a}. The parameter α, defined elsewhere herein, is intialized. The set of complementary feature [symbol] ′ is initialized as the difference between the set of features [symbol] of the entire domain (all features and all feature values) and the set of features [symbol] ^{a} of the anomalous subset. [symbol] is initialized to the count of features in the selected feature set [symbol] . The selected feature set [symbol] is enqueued in queue [symbol] .

In the while loop of the algorithm, while the normal score s^{norm} is greater than a given threshold and the queue [symbol] is not empty, a feature f^{r} is popped from the queue [symbol] and f′^{r} is set to the designated feature f′ of the set of complementary features [symbol] ′ (f′=feaure from the complement set (not in the anomolouis subset) that matches the feature popped out from the queue). Given the teachings herein, the threshold can be determined heuristically by the skilled person as, for example, a distribution score or fixed value.

The outter “for” loop goes through different feature values \hat{f}ᵢ^{r} of the dequeued feature f^{r} while the inner “for” loop goes through different feature values \hat{f}ⱼ′^{r} of the complement feature f′^{r}. The normal subset X^{norm} is recalculated after a feature value from the anomalous set is substituted with a feature value of the complement set and the score s^{norm} is calculated based on X^{norm}, where q is a constant and y is an output. The statistical significance p_value(s^{norm}) of the score and the odds ratio are calculated, and the normal tuple [symbol] ^{norm} is created. Once the normal score s^{norm} is greater than a given threshold, the while loop is ended and the current X^{norm}, s^{norm}, and [symbol] ^{norm} values are returned. Given the etachings herein, the skilled artisan will be able to employ the maximum log likelihood, the Bernouli likelihood, select q, and so on.

### System Components

Generally, systems and methods for feature-value perturbations of differentiated subgroups (post-discovery analysis) are disclosed. The most significant feature values of an anomalous subset that confer the greatest contribution to the anomalous score are identified. In a second step, through perturbations of the identified features, an example method identifies the minimal set of changes necessary to significantly change the anomalous behaviors of the subset. An exemplary embodiment of a system, according to an aspect of the invention, comprises:
computing a weighted contribution of features and feature values to the anomalousness of an identified subset (e.g., by scoring the deviation of each unique value of a feature compared to the whole dataset);
encoding the systemic deviation for each feature by computing the standard deviation of the data conditioned on each of a plurality of features in the identified subset;
ranking the features in descending order of their deviation scores;
performing cross-substitutions for each of the feature values identified;
scoring each newly resultant subset from cross-substitution using an expectation-based scoring statistic;
obtaining measures (odds ratio and p-value) of effect that define the statistical significance of the change in new scores in relation to the null hypothesis; and
determining a threshold measure to identify when the score has significantly dropped and stop the search.

### Feature Relevance Component

The feature value takes as input the differentiated (anomalous) subset, the anomalous score, and the measures of effect (e.g., p-value and odds-ratio for some distribution). The contribution of each feature value to the anomalous score is ranked. In one example embodiment, the method is based on the standard deviation (although other methods are contemplated). For example, the result variable, or score, of the level of insulin of a population may be considered. The global mean (μ_{g}) is the overall average of outputs in the dataset:

$${μ}_{g} = \frac{{\sum }_{i} ( {y}_{i} )}{\vert D \vert}$$

The subset mean (μ_{SS}) is the mean of all outputs of records containing feature values from the deviating subset (anomalous subgroup). To find the feature relevance, the following algorithm is performed:

For each feature value (fv) in the anomalous subgroup:
records-fv←record in D if the record has fv; (records-fv gets any record in the overall population D that has the corresponding feature value)
for every i^{th} record in records-fv:
   obtain the marginal output for the feature value for the i^{th} record: αᵢ=y value of the i^{th} record in the set of records with the feature value;
score (weight) of each feature|value in the anomalous subset is obtained by the standard deviation from the mean:

$${σ}_{g} = \sqrt{\frac{\sum {( {α}_{i} - {μ}_{g} )}^{2}}{N}}$$

The score σ_{g} indicates the relevance of the feature value.

### Cross-Substitution and Dynamic Programming Approach

Given an anomalous subset, the complement set, the threshold score/distribution, and measures of effects, a goal is to find the least number of substitutions on the feature values of the anomalous subset with values from the complement set that lie within the threshold score or distribution. It is advantageous to reduce the feature space such that the number of computations is reasonable.

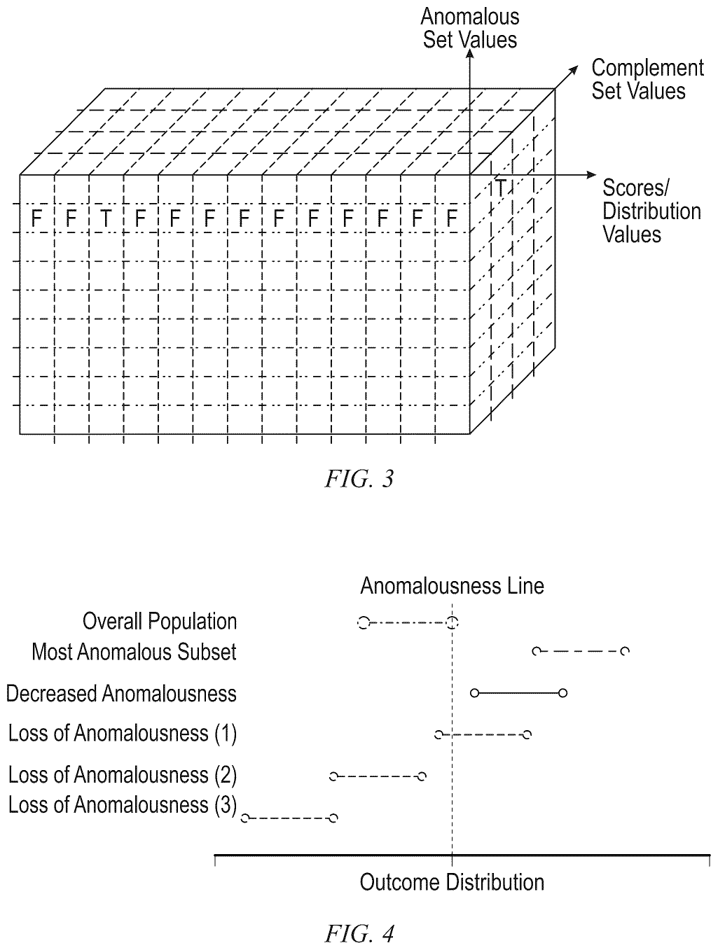

FIG. 3 represents a model for exploring the feature space to identify the minimal perturbations to a set of features of an anomalous subgroup that result in a reduction of the level of anomalousness, in accordance with an example embodiment. The intersection of each cell corresponds to a particular set of feature values of the anomalous subgroup (corresponding to the y-axis) and a particular set of feature values of the complement subgroup (corresponding to the z-axis), which represent a substitution from the value of the anomalous set to the value of the complement set during cross-substitution. As the feature values are changed as each cell is encountered, the score/distribution value for the corresponding set of feature values of the anomalous subgroup and the particular set of feature values of the complement subgroup will vary. (The model of FIG. 3 is similar to the subset sum problem.)

The transition from one cell to another represents a substitution of a feature value of the anomalous subgroup with a feature value of the complement subgroup. For the avoidance of doubt, in one or more embodiments, every substitution involves two values and a change from a value in the anomalous set to a value in the complement set-a cell represents this substitution. Each cell-to-cell move changes one feature value; that is, transitions represent a single substitution. A Boolean value of each cell represents whether a given transition sufficiently reduces anomalousness to the normal distribution; that is, T represents that the corresponding subgroup has a normal distribution and F represents that the corresponding subgroup has an anomalous distribution. If the distribution gets more anomalous after substitution, the substitution is removed; if the distribution gets less anomalous after substitution, the substitution is kept; and if the distribution becomes non-anomalous after substitution, the method stops the process and reports the set of feature value changes. In one example embodiment, the process continues to search for other alternate sets of substitutions. Memoization is used to store scores of prior substitution combinations.

FIG. 4 illustrates the range of a distribution corresponding to an overall population and five subgroups in accordance with an example embodiment. The first subgroup is most anomalous, the second subgroup is less anomalous, and the third subgroup is considered to be non-anomalous. The fourth and fifth subgroups are non-anomalous.

### Dynamic Programing for Cross Substitution

In one example embodiment, a method for dynamic programming for cross substitution includes the operations of:

```
  _substitutions = [ ]; (Clear the set of substitutions)
  Memory = [ ]; (Clear memory).
  DP_Based_Cross_Sub(ci_lower_subset, subset); (Take the lower confidence interval of
the given subset and the subset itself).
    If (subset = domain); (If the subset is the whole feature set (domain, return zero).
      return { }
    if ci_lower_subset<ci_upper_domain or len(_substitutions)=len(all_substitutions);
  (If the lower confidence interval of the subset is less than the upper confidence interval of
  the domain or all substitutions have been considered, return the set of substitutions).
      return_substitutions
    else:
      if (ci_lower_subset < ci_lower_anomalous)
        append(_substitutions,curr_sub); (add current substitution to the set of
      substitutions if the lower confidence interval of the current subset is less than
      the lower confidence interval of the anomalous subset).
        memory[curr_sub] = ci_upper_domain − ci_lower_subset; (set the value of
      the current subset to the difference between the upper confidence interval of the
      domain and the lower confidence interval of the subset if the lower confidence
      interval of the current subset is less than the lower confidence interval of the
      anomalous subset).
        next_sub = select_next_substitution(ranked_anom, ranked_compl,
        remainder_weight); (the next substitution, next_sub, is selected).
        new_subset = substitute(subset,next_sub); the new subset, new_subset, is
    generated based on the current subset and the selected next substitution, next_sub).
        ci_lower_subset, ci_upper_subset = get_beta_distro_ci_bounds( ); take
    statistical measure of the lower confidence interval of the current subset and the
    upper confidence interval of the current subset).
        DP_Based_Cross_Sub(ci_lower_subset, new_subset); (iteratively call
    method with the new lower confidence interval and the new subset).
        return_substitutions
```

### Use Cases

Exemplary embodiments are useful for counterfactual analysis of the differentiated subgroup, to identify possible scenarios that could have led to better behavior of the anomalous groups. Similarly, the following scenarios can be implemented:
optimization of treatment and cost: a study to identify which features are most impactful to the deviating behavior of specific subgroups. By identifying these features, it is possible to target remedial measures in an optimal manner, especially, in cases where cost and life is critical, such as in healthcare;
assist in intervention planning: by understanding the possible feature perturbations and to the extent that these perturbations reduce the anomalousness of an identified subpopulation (subgroup), better interventions can be designed for such subgroups in the future; and
discovery of non-treatment interventions: given that the post-discovery work extends analysis of the features of the anomalous subgroup, non-treatment features can be identified that can help improve the impact of interventions, such as behavioral characteristics of a population that can be designed together with interventions to have better impact.

### Validation Use Case

A healthcare database was analyzed to validate the disclosed framework. The healthcare database was fully deidentified, and a target cohort was defined as newly diagnosed Osteoarthritis (OA) Knee patients receiving outpatient services during a given time period; and the outcome cohort was defined as outpatient OA Knee patients who underwent any Major Joint Replacement (MJR) surgery during the given time period.

The final analytic dataset consisted of 337,078 OA Knee patients, of whom 13,651 (3.9%) had MJR surgeries. Five discrete features with different cardinalities was extracted as follows: a demographic characteristic 3 having ranges E, F, G, H, and I, the demographic characteristic 1 having a value of A or B, region (North Central, Northeast, South, Unknown, West), metropolitan statistical area (Rural, Urban), and employment status (Active Full Time, Active Part-Time or Seasonal, Insurance Continuee, Early Retiree, Long Term Benefit Receiver, Retiree Eligible for Government Retiree Medical Insurance (GRMI), Other/Unknown, Retiree (Status Unknown), Surviving Spouse/Dependent).

The observed outcome was defined as a binary indicator variable yᵢ such that yᵢ=1 for OA Knee patients who underwent an MJR surgery, and yᵢ=0 otherwise. The expected outcome was defined as a simple mean of the observed outcome. Accordingly, the final analysis dataset consisted of five features, one observed outcome, and one expected outcome.

The discovery method used an automatic stratification approach to identify the highest-scoring subset with the most evidence of having higher rates of MJR surgeries than the global average in the dataset. To correct for multiple hypothesis testing and estimate the statistical significance of the identified anomalous subset, parametric bootstrapping was used to compute the empirical p-value of the subset. Using this approach, it was discovered that OA Knee patients who were 55 to 64 years old, resided in the West, North Central or South regions of the United States, and have an employment status as Full-time, Retiree Eligible for Government Retiree Medical Insurance, Early Retiree, Insurance Continuee, or Long Term Benefit Receiver, were most likely to undergo MJR surgeries. Among this subpopulation consisting of 135,115 OA Knee patients, the rate of MJR surgeries was significantly higher (6% in the subpopulation compared to 3% in the complement subpopulation; odds ratio 2.09, 95% confidence interval corresponding to odds ratio range 2.02 to 2.17, p-value <0.001).

For the discovery method to identify and characterize the highest scoring (most deviating) subset of feature values, automatic stratification was used to identify the highest-scoring subset with the most evidence of having higher rates of MJR surgeries than the global average in the disclosed dataset. To correct for multiple hypothesis testing and estimate the statistical significance of the identified anomalous subset, parametric bootstrapping was used to compute the empirical p-value of the subset. Using this approach, it was discovered that OA Knee patients who are 55 to 64 years old, reside in the West, North Central or South regions of the United States, and have an employment status as Full-time, Retiree Eligible for Government Retiree Medical Insurance, Early Retiree, Insurance Continuee, or Long Term Benefit Receiver, were most likely to undergo MJR surgeries. Among this subpopulation consisting of 135,115 OA Knee patients, the rate of MJR surgeries was significantly higher (6% in the subpopulation compared to 3% in the complement sub population; odds ratio 2.09, 95% confidence interval corresponding to odds ratio range 2.02 to 2.17, p-value <0.001).

### Feature-Value Perturbations in Differentiated Subgroups

For the post-discovery steps (perturbations of feature-values for the deviating subgroup), the relevance of features to the anomalous score was first determined. For the MJR dataset, the expected value of the output in D was μ_{g}=0.0389. The expected value of the anomalous subset was μₛₛ=1.0 (all records with the combination of features in the anomalous subset underwent MJR surgery). The expected output for each feature-value in the anomalous subset was then calculated. For example, in the anomalous subset, one of the feature values for the feature Employment Status (EESTATU) was “Retiree Eligible for Government Retiree Medical Insurance”. It was found that the expected value of this feature value in the dataset is e₁=0.057. Consequently, two deviation statistics were calculated: i) a subset deviation: deviation of the feature value from the anomalous subset δ_{1_s}=e₁−μₛₛ=−0.943; and ii) global deviation: deviation of the feature value from the expected value of the dataset δ_{1_g}=e₁−μ_{g}=0.018. The deviation ratio of the two deviations δ_{r_1}=δ_{1_s}/δ_{1_g}=−52.21 is then used to score and rank each feature value against the other feature values in the anomalous subset. Alternatively, the standard deviation of the feature values in the differentiated subgroup can be calculated:

$${σ}_{g} = \sqrt{\frac{\sum {( {α}_{i} - {μ}_{g} )}^{2}}{N}}$$

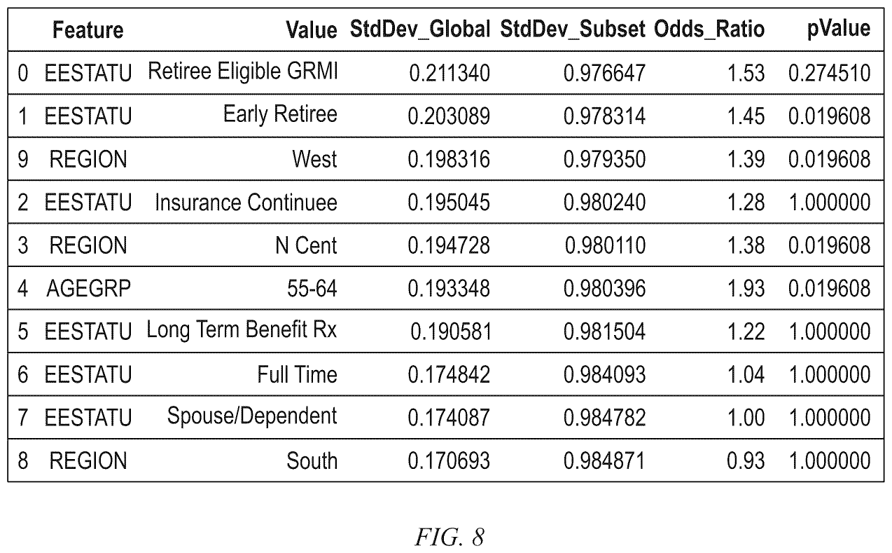

The table of FIG. 8 illustrates the relevance of feature values based on the standard deviations from the global average, in accordance with an example embodiment. The table shows the results of the feature relevance step of the post-discovery process. In the feature relevance stage, for the MJR use case, the ranking of feature relevance is therefore as follows: 1. Employment Retiree Eligible for Government Retiree Medical Insurance, 2. Early Retiree, and so on.

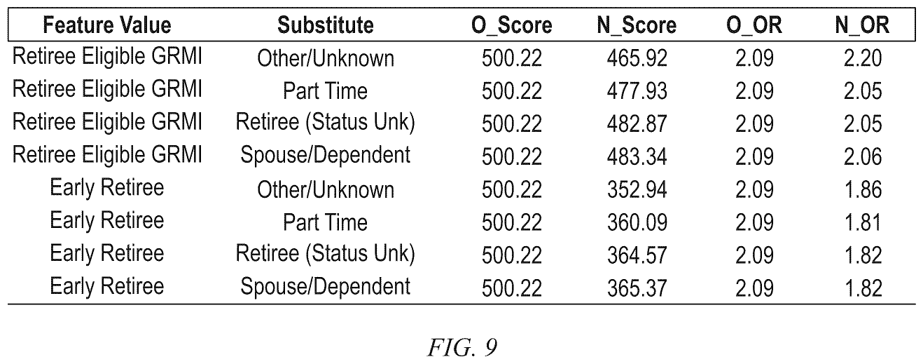

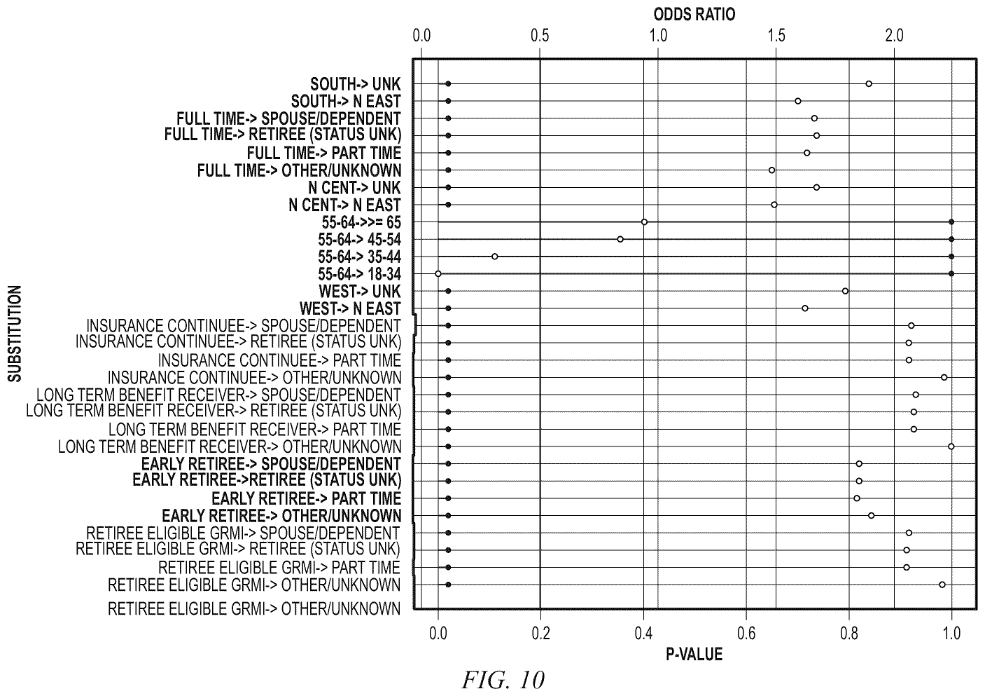

In the cross-substitution stage, the anomalous subset was perturbed by changing feature values. Of note is that when a feature value is cross-substituted from the complement for an anomalous feature value, a new subset is effectively created. Consequently, a new anomalous score, the empirical p-value of the score, and the odds ratio of the outcome in the new subset compared to its complement were calculated. For example, in the MJR dataset, the anomalous subset exhibited a score of 500.22, empirical p-value=0.019608, and an odds ratio of 2.09. By substituting the employment status value “Retiree Eligible for Government Retiree Medical Insurance” in the anomalous subset with “Other Unknown” in the complement subset, a new subset with anomalous score of 465.92, empirical p-value of 019608, and an odds ratio of 2.20 is obtained. These statistics are obtained using the same scoring method used in the discovery stage to allow for consistency in comparison. The table of FIG. 9 shows the post-discovery scores for single substitutions of the two most significant anomalous feature values. Although the p-values stay constant as seen in FIG. 10, a considerable degradation of the anomalous score and the Odds Ratio is observed.

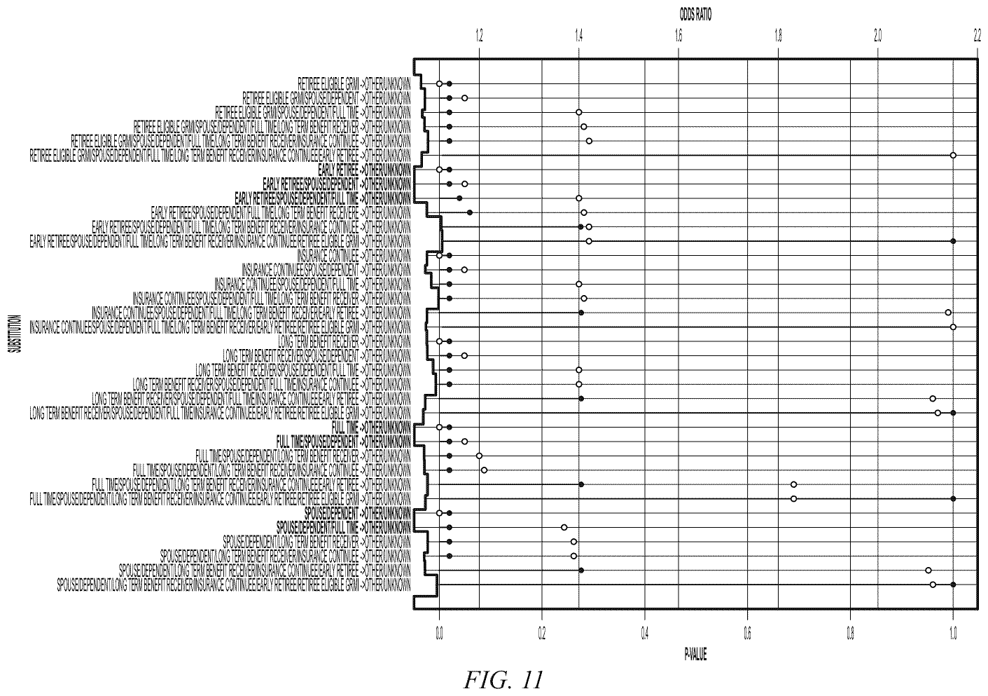

FIGS. 10 and 11 portray the effects of making substitutions to single feature values and making multiple m:1 substitutions, respectively. FIG. 10 illustrates the cross-substitution of single feature values in the anomalous subset against the two measures of effect: p-value and odds ratio, in accordance with an example embodiment. FIG. 11 illustrates multiple [m:1] cross-substitutions of feature values in the anomalous subset against the two measures of effect: p-value and odds ratio, in accordance with an example embodiment. Two measures of effect are plotted, namely: the statistical p-value of the anomalous score and the odds ratio. For the single substitutions, it is observed that the p-value statistic remains relatively the same for most feature value perturbations. However, there are a few single substitutions that cause a statistically significant change in the anomalous score, namely, the substitutions on the feature: demographic characteristic 3 from range H to range E; H to range F; H to range G; H to range I. As the perturbations are increased to m:1 multiple feature value substitutions, as shown in FIG. 11, more optimal cross-substations are realized. From the single substitutions plot, it can be concluded thus: if the sub-population that belong to the anomalous subgroup had been changed from the specific range H to the ranges of E, G, and I, there would not have been a major joint replacement surgery. Note that single value perturbations to the most relevant feature: Retiree Eligible for Government Retiree Medical Insurance did not cause any statistically significant change to the anomalous score. This can be attributed to the fact that the feature employment status (EESTATU) is multi-valued in the anomalous subset, a single change in one of the feature values has little effect especially since there are three more feature values considered. It is expected that higher combination substitutions will reveal better insights into this phenomenon. The odds ratio, on the other hand, indicates a variation of the score from the substitutions. For example, the odds ratio for 55-64->>65 is relatively higher than 55-64->18-34 meaning that the former is more likely to occur in this dataset as opposed to the latter. Similarly, the substitution: Retiree Eligible for Government Retiree Medical Insurance->Other Unknown, has a very high odds ratio, attesting to the possibility of such a change in this dataset, albeit with no change in the statistically significant measure (explained above).

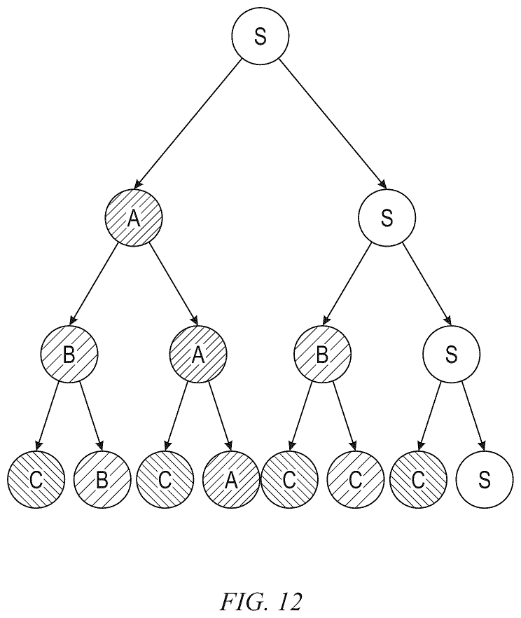

FIG. 12 illustrates an example tree for identifying the minimal perturbations to a set of features of an anomalous subgroup that result in a reduction of the level of anomalousness, in accordance with an example embodiment. Each node represents a different subgroup generated based on a different set of feature values, where the root node represents the anomalous subgroup. Each edge represents a substitution of a given feature value. The tree of FIG. 12 is traversed using backtracking. For example, starting at the root node, a transition to subgroup A is made by substituting a single feature value for the complement subgroup and the generated subgroup is evaluated. If the subgroup is less anomalous (or exhibits the same level of anomalousness), the traversal continues in the same direction; otherwise, the traversal backtracks to the previous node and continues in a new direction. In one example embodiment, once a subgroup is encountered exhibiting a level of anomalous within a given threshold, the search stops.

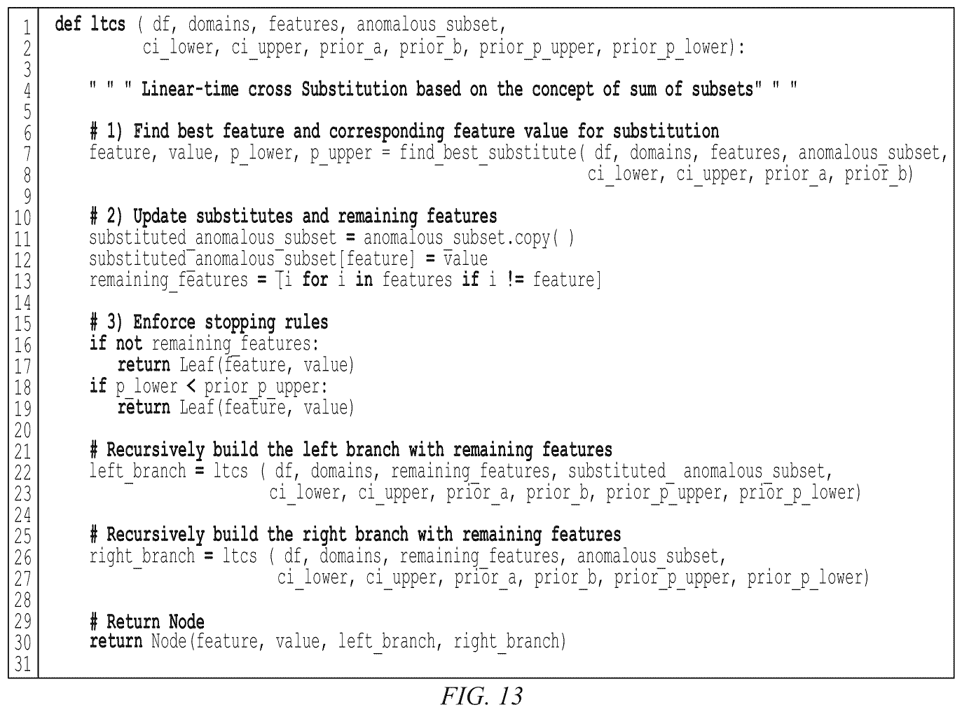

FIG. 13 is an example backtracking algorithm for identifying the minimal perturbations to a set of features of an anomalous subgroup that result in a reduction of the level of anomalousness, in accordance with an example embodiment. The backtracking algorithm provides linear-time cross-substitution based on the concept of sum of subsets. The data input includes df (rows of records of different individuals where the columns correspond to different features and each corresponding cell includes a value for the feature of the corresponding individual) and domains is the set of all features and set of all corresponding feature values. Initially, the best feature and corresponding feature value for substitution is determined (section #1) using, for example, the techniques described above. For example, given an anomalous subset, the original data, and a list of features in the data, derive a feature value that has the most impactful contribution to the anomalousness. The substitutions and remaining features are updated (section #2). For example, a tree structure defining all possible substitutions, where each node of the tree represents a feature value substitution, is traversed in a brute-force manner. The stopping rules are considered (section #3). For example, if there are no features remaining for processing in the branch of the tree being processed or the substitutions have resulted in a non-anomalous distribution, the feature and feature value of the leaf node are returned. The left branch of the tree and the right branch of the tree are recursively built with the remaining features, and the parameters of the node are returned.

### Embodiment Clinical Practice Example(s)

Results of the post discovery process are used to design the next interventions, e.g. if perturbable anomalous features are behavioral features (such as engaging in a harmful behavior that can be modified). New interventions can include supplementary steps to increase impact. In another embodiment, the perturbation of features can be employed in an approach to determine causality and effect of given combinations of features on the specific behavior of a given set. In yet another embodiment, the feature relevance ranking can be used in a system to determine the top N features for an algorithm.

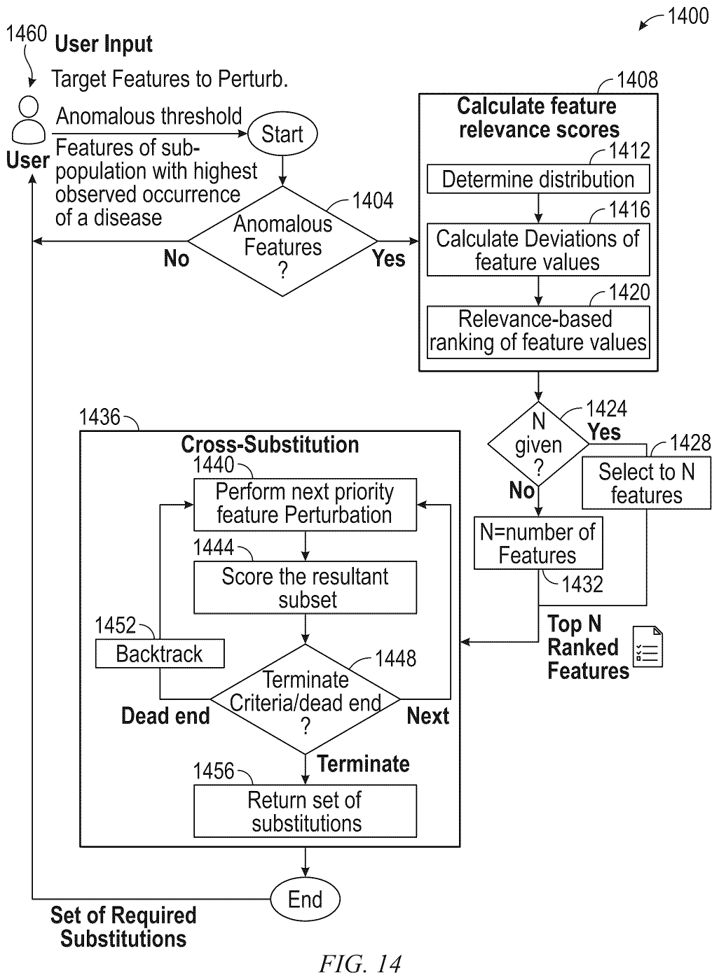

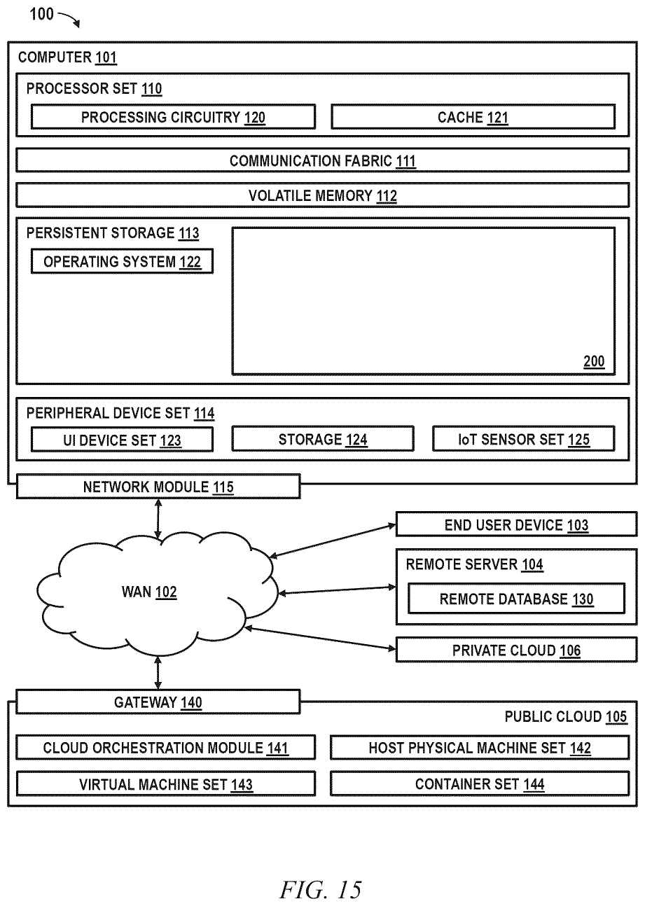

FIG. 14 is a flowchart 1400 for determining feature-value perturbations that change an anomalous subgroup to non-anomalous for an example clinical practice system, in accordance with an example embodiment. In one example embodiment, a user 1460, such as a domain expert, submits a set of features to perturb, such as a set of features of a sub-population with the highest observed occurrence of a disease. A check is performed to determine if the submitted set of features to perturb correspond to an anomalous subgroup (decision block 1404). If the submitted set of features to perturb does not correspond to an anomalous subgroup (NO branch of decision block 1404), the method 1400 returns an error message to the user 1460 and awaits the submission of another set of features to perturb. Otherwise (YES branch of decision block 1404), the feature relevance is calculated (operation 1408), where the distribution is determined (operation 1412), the deviations of feature values are calculated (operation 1416), and the feature values are ranked based on relevance (operation 1420).

A check is performed to determine if a number N was given by the user 1460 (decision block 1424). If the user 1460 provided the number N (YES branch of decision block 1424), N features are selected, where N is the value provided by the user (operation 1428) and the method 1400 proceeds to operation 1436; otherwise (NO branch of decision block 1424), N is set to the total count of available features (operation 1432) and the method 1400 proceeds to operation 1440. During operation 1436, cross-substitution is performed, where the next priority feature perturbation is performed (operation 1440) and the score for the resulting subset (subgroup) is calculated (operation 1444). Given the teachings herein, the skilled artisan can heuristically determine the value of N for operation 1428.

A check is performed to determine: if the next perturbation is to be performed, a dead end was encountered, or the termination criteria was satisfied (decision block 1448). If the next perturbation is to be performed (NEXT branch of decision block 1448), the method 1400 proceeds with operation 1440; if a dead end was encountered (DEAD END branch of decision block 1448), a backtrack operation 1452 on the tree is performed and the method 1400 proceeds with operation 1440; otherwise (TERMINATE branch of decision block 1424), the set of substitutions is returned (operation 1456) and the method 1400 ends.

Given the discussion thus far, it will be appreciated that, in general terms, an exemplary method, according to an aspect of the invention, includes the operations of identifying a plurality of key features that contribute to a level of anomalousness of an anomalous subgroup (operation 1408); identifying one or more minimal perturbations to a set of features of the anomalous subgroup that result in a reduction of the level of anomalousness (operation 1436); and facilitating applying the one or more minimal perturbations to members of the anomalous subgroup (operation 1456).

In one aspect, a non-transitory computer readable medium comprises computer executable instructions which when executed by a computer cause the computer to perform the method of identifying a plurality of key features that contribute to a level of anomalousness of an anomalous subgroup (operation 1408); identifying one or more minimal perturbations to a set of features of the anomalous subgroup that result in a reduction of the level of anomalousness (operation 1436); and facilitating applying the one or more minimal perturbations to members of the anomalous subgroup (operation 1456).

In one aspect, an apparatus comprises a memory and at least one processor, coupled to the memory, and operative to perform operations comprising identifying a plurality of key features that contribute to a level of anomalousness of an anomalous subgroup (operation 1408); identifying one or more minimal perturbations to a set of features of the anomalous subgroup that result in a reduction of the level of anomalousness (operation 1436); and facilitating applying the one or more minimal perturbations to members of the anomalous subgroup (operation 1456).

In one example embodiment, the identified key features are ranked (operation 236).

In one example embodiment, the identifying the plurality of key features further comprises scoring a contribution of a selected feature of the plurality of key features to the level of anomalousness of the anomalous subgroup (operation 232).

In one example embodiment, the identifying the one or more minimal perturbations uses cross-substitution by minimally altering a version of a defining set of features of the anomalous subgroup obtained by replacing a value of the version of the defining set of features with a value from a complement set of features of a complement subgroup and scoring the version of the defining set of features during a cross-substitution phase 212 (operation 220).

In one example embodiment, the minimally altering of the version of the defining set of features starts with a highest ranked feature of the identified key features to create a new subgroup (operation 216).

In one example embodiment, the scores of the version of the defining set of features are statistically evaluated to identify a set of perturbations to the set of features of the anomalous subgroup that bring the anomalous distribution to a normal distribution (operation 224).

In one example embodiment, the method is halted when a statistical significance of the minimally altered version of the defining set of features surpasses a given threshold.

In one example embodiment, measures of effect are obtained, the measures of effect including an odds ratio and a p-value, that define the statistical significance and a threshold measure is determined to identify when a corresponding score has significantly dropped.

In some cases, a cross-substitution function is optimized to run in optimal time (e.g., linear or logarithmic time).

In one example embodiment, the ranking the identified key features further comprises computing a standard deviation σ_{g} of a given feature value where a global mean μ_{g} is an overall mean of outputs in an original dataset D defined as:

$${μ}_{g} = \frac{{\sum }_{i} ( {y}_{i} )}{\vert D \vert} ;$$

computing a subset mean μₛₛ defined as a mean of all outputs of records containing feature values from the set of features of the anomalous subgroup; for each feature value fv in the set of features of the anomalous subgroup, adding a given record in the original dataset D to a set of records-fv if the given record has the feature value fv, and obtaining, for every i^{th} record in the set of records-fv, a marginal output for the given feature value for an i^{th} record where αᵢ equals a y value of the i^{th} record in the set of records having the feature value; and obtaining a score for each feature value pair of the plurality of key features that contribute to the level of anomalousness by computing a standard deviation from the mean:

$${σ}_{g} = \sqrt{\frac{\sum {( {α}_{i} - {μ}_{g} )}^{2}}{N}}$$

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as post discovery analysis mechanism 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
identifying a plurality of key features that contribute to a level of anomalousness of an anomalous subgroup;
identifying one or more minimal perturbations to a set of features of the anomalous subgroup that result in a reduction of the level of anomalousness; and
facilitating applying the one or more minimal perturbations to members of the anomalous subgroup.

2. The method of claim 1, further comprising ranking the identified key features.

3. The method of claim 2, wherein the ranking the identified key features further comprises:
computing a standard deviation σ_{g} of a given feature value where a global mean μ_{g} is an overall mean of outputs in an original dataset D defined as:
$${μ}_{g} = \frac{{\sum }_{i} ( {y}_{i} )}{\vert D \vert} ;$$
computing a subset mean μₛₛ defined as a mean of all outputs of records containing feature values from the set of features of the anomalous subgroup;
for each feature value fv in the set of features of the anomalous subgroup, adding a given record in the original dataset D to a set of records-fv if the given record has the feature value fv, and obtaining, for every i^{th} record in the set of records-fv, a marginal output for the given feature value for an i^{th} record where αᵢ equals a y value of the i^{th} record in the set of records having the feature value; and
obtaining a score for each feature value pair of the plurality of key features that contribute to the level of anomalousness by computing a standard deviation from the mean:
$${σ}_{g} = \sqrt{\frac{\sum {( {α}_{i} - {μ}_{g} )}^{2}}{N}}$$

4. The method of claim 3, further comprising calculating, for each feature value fv of the plurality of key features that contribute to the level of anomalousness, deviations of eⱼ from the global mean μ_{g} based on δⱼ=eⱼ−μ_{g}, where:
$${e}_{j} = 𝔼 ( {f}_{j}^{a} ) = \frac{{\sum }_{i} ( {y}_{i} \vert {f}_{j}^{i} = {f}_{j}^{a i} )}{\vert ( {x}_{i} \vert {f}_{j}^{i} = {f}_{j}^{a i} ) \vert}$$
and wherein fⱼ^{a} represents the jt^{h} feature of the anomalous subset, [symbol] ( ) is a function for determining an expected value, and the feature value fv of the plurality of key features that contribute to the level of anomalousness are ranked based on the calculated deviations as:
$$rank ( {f}_{j}^{a} ) < rank ( {f}_{k}^{a} ) if {δ}_{j} > {δ}_{k} .$$

5. The method of claim 1, wherein the identifying the plurality of key features further comprises scoring a contribution of a selected feature of the plurality of key features to the level of anomalousness of the anomalous subgroup.

6. The method of claim 1, wherein the identifying the one or more minimal perturbations uses cross-substitution by minimally altering a version of a defining set of features of the anomalous subgroup obtained by replacing a value of the version of the defining set of features with a value from a complement set of features of a complement subgroup and scoring the version of the defining set of features during a cross-substitution phase.

7. The method of claim 6, wherein the minimally altering of the version of the defining set of features starts with a highest ranked feature of the identified key features to create a new subgroup.

8. The method of claim 6, further comprising statistically evaluating the scores of the version of the defining set of features to identify a set of perturbations to the set of features of the anomalous subgroup that bring the anomalous distribution to a normal distribution.

9. The method of claim 8, further comprising halting the method when a statistical significance of the minimally altered version of the defining set of features surpasses a given threshold.

10. The method of claim 9, further comprising obtaining measures of effect, the measures of effect including an odds ratio and a p-value, that define the statistical significance and determining a threshold measure to identify when a corresponding score has significantly dropped.

11. The method of claim 1, further comprising computing one or more characterization metrics as scores to describe the level of anomalousness, odds ratios between the anomalous subgroup and an overall population where the odds ratios evaluate a likelihood of experiencing an outcome of an interest in each subset resulting from substitutions compared to the overall population, a confidence interval, and an empirical p-value of the odds ratios defined by:
$$Γ ( {X}^{norm} ) = {max}_{q} log ( q ) {\sum }_{i ∈ S} {y}_{i} - \vert {X}^{norm} \vert * log ( 1 - {μ}_{g} + q {μ}_{g} )$$
where
$${μ}_{g} = \frac{{\sum }_{i} ( {y}_{i} )}{\vert D \vert} , D$$
represents the overall population, and X^{norm} is a set of features and corresponding feature values obtained from a given combination of perturbations of the set of features of the anomalous subgroup with incremental perturbations, q is an assumed constant multiplicative increase in outcome odds for any given subgroup.

12. The method of claim 1, wherein the identifying the one or more minimal perturbations further comprises:
clearing a set of substitutions;
determining a lower confidence interval of the anomalous subgroup and the newly created subset resulting from the perturbation;
returning an indication of an empty set in response to the subgroup being equivalent to the domain;
returning the set of substitutions in response to the lower confidence interval of the anomalous subgroup being less than an upper confidence interval of the domain or all substitutions having been considered;
adding a current substitution to the set of substitutions in response to a lower confidence interval of a current subgroup is less than the lower confidence interval of the anomalous subset;
setting a value of the current subgroup to a difference between the upper confidence interval of the domain and the lower confidence interval of a current subset if the lower confidence interval of the current subgroup is less than the lower confidence interval of the anomalous subgroup;
selecting a next substitution;
generating a new subgroup based on the current subset and the selected next substitution;
generating a statistical measure of the lower confidence interval of the current subgroup and an upper confidence interval of the current subgroup;
iteratively calling the method with a new lower confidence interval and the new subgroup; and
providing the set of substitutions.

13. The method of claim 1, wherein the facilitating applying the one or more minimal perturbations to the members of the anomalous subgroup includes creating and administering a medical treatment to at least some of the members of the anomalous subgroup based on the one or more minimal perturbations.

14. The method of claim 1, further comprising deriving a scoring metric from an expectation-based scan statistic similar to a metric employed in a corresponding discovery method.

15. The method of claim 1, wherein a cross-substitution function is optimized to run in optimal time.

16. The method of claim 1, further comprising computing a weighted contribution of a given feature and corresponding feature value to the level of anomalousness by scoring a deviation of each unique value of the given feature for the anomalous subgroup in comparison to the entire population.

17. The method of claim 1, further comprising generating and administering a set of prescribed medical therapies based on the one or more minimal perturbations.

18. A computer program product, comprising:
one or more tangible computer-readable storage media and program instructions stored on at least one of the one or more tangible computer-readable storage media, the program instructions executable by a processor, the program instructions comprising:
identifying a plurality of key features that contribute to a level of anomalousness of an anomalous subgroup;
identifying one or more minimal perturbations to a set of features of the anomalous subgroup that result in a reduction of the level of anomalousness; and
facilitating applying the one or more minimal perturbations to members of the anomalous subgroup.

19. A system comprising:
a memory; and
at least one processor, coupled to said memory, and operative to perform operations comprising:
identifying a plurality of key features that contribute to a level of anomalousness of an anomalous subgroup;
identifying one or more minimal perturbations to a set of features of the anomalous subgroup that result in a reduction of the level of anomalousness; and
facilitating applying the one or more minimal perturbations to members of the anomalous subgroup.

20. The system of claim 19, the operations further comprising ranking the identified key features.
